(19) United States
(12) Patent Application Publication
(10) Pub. No.: US 2006/0044314 A1
(43) Pub. Date: Mar. 2, 2006

(54) System and method for information handling system display selection

(76) Inventors: Sunil Pandita, Austin, TX (US); Dirie Herzi, Round Rock, TX (US); Matthew G. Page, Pflugerville, TX (US)

Correspondence Address: HAMILTON & TERRILE, LLP, P.O. BOX 203518, AUSTIN, TX, 78720, US

(21) Appl. No.: 10/924,683

(22) Filed: Aug. 24, 2004

(51) Int. Cl. G06F 15/16; G09G 5/00

(52) U.S. Cl. 345/502; 345/172; 345/1.1; 345/1.3

(57) ABSTRACT

Information handling system display configuration selection is enhanced through a display configuration dialog box that presents available display configurations for selection. A display configuration engine communicates with the BIOS of the information handling system to determine the display configuration sequence, the available display configurations based upon the displays attached to the information handling system and the next display configuration in the sequence based on the next display configuration to be initiated by the BIOS. The available display configurations are presented in the dialog box with the next display configuration highlighted so that a user toggles through the available display configurations to select initiation of a desired display configuration. For instance, simultaneous activation of the function and F8 keys presents the dialog box, toggling of the F8 key with the function key held advances the highlight through the sequence in the dialog box, and release of the function key commands the BIOS to initiate the highlighted display configuration.

### BACKGROUND OF THE INVENTION

1. Field of the Invention

The present invention relates in general to the field of information handling system display selection, and more particularly to a system and method for a dialog presentation to select a display configuration from available configurations.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often interact with a number of peripherals to display, communicate, print or otherwise process information. For instance, portable information handling systems are often used in an office environment to display information at a fixed station through a CRT or flat panel display, in a mobile environment to display information through an integrated LCD panel display and in a public environment to display information through a projector for presentation to a group of people. As an example, a sales person prepares a sales presentation in an office environment with the portable information handling system interfaced with a docking station having a fixed display. The sales person takes the portable information handling system on a sales trip and uses the integrated LCD in route to review and practice the sales presentation. Once at the presentation location, the sales person uses both the LCD and an additional display port interfaced with a projector to display the presentation through the projector while having the LCD as a more convenient interface. Portable information handling systems typically have multiple display ports to accommodate external displays, such as DVI and VGA ports. The selection of ports for display is generally performed by the system BIOS when a user inputs a display switch key combination, such as simultaneous inputs of the function and F8 keys.

The selection of a display configuration by simultaneous input of the function and F8 keys is not an intuitive interface since the user cycles through each display configuration and selects the configuration based on what is displayed, often leading to user difficulty such as when a display is inoperative. One difficulty is that a user who is attempting to select a desired display configuration state does not have direct information from the information handling system of the current display configuration state or the next state that will be called if the function and F8 keys are activated. Instead, the user generally must toggle through each successive display configuration state in an order set by the BIOS until the user obtains a desired state. As an example, if a portable information handling system having an LCD also has a CRT display connected to a VGA port and a projector connected to a DVI port, at least six display configuration states are available in the following order: LCD only, LCD and CRT, CRT only, LCD and DVI, DVI, and CRT and DVI. Thus, in order to switch from an LCD only display to a CRT and DVI display, the user toggles the function and F8 keys five separate times and must wait for completion of the five display switches before arriving at the desired display configuration state. If the user inadvertently toggles an additional function and F8, the user must toggle through all states again to find the desired state. Each display configuration state change takes time to accomplish since the BIOS, video BIOS, keyboard controller, operating system and video driver typically must interact to determine the next display configuration, initiate the configuration switch event and complete the display switch event. System resources are wasted in the selection of intermediate display configurations between the initial and desired display configurations.

### SUMMARY OF THE INVENTION

Therefore a need has arisen for a system and method which presents available display configurations for selection by an information handling system user.

In accordance with the present invention, a system and method are provided which substantially reduce the disadvantages and problems associated with previous methods and systems for selection of a desired of plural available information handling system display configurations. Available display configurations are retrieved from the BIOS and presented in a dialog box to allow selection of a desired display configuration for initiation by the BIOS.

More specifically, a display configuration engine, such as an application running in cooperation with an information handling system operating system, communicates with the BIOS of the information handling system to retrieve the display configuration selection sequence. Upon detection of a user request to change the display configuration, the BIOS provides the display configuration engine with the attached display devices and the next display configuration in the sequence. The display configuration engine presents a dialog box at the currently activated attached displays that shows the sequence of display configurations for the attached displays and highlights the next display configuration in the sequence. For instance, the dialog box presents the available display configurations upon detection of simultaneous activation of the function and F8 keys. The user toggles through the available display configurations to select a desired display configuration, such as by activating the F8 key with the function key held down so that each F8 key activation highlights the next display configuration in the sequence order. Upon highlighting of the desired display configuration, selection is performed by release of the function key with the display configuration engine communicating to the BIOS the highlighted display configuration and the BIOS initiating selection of the highlighted display on detection of release of the function key by the keyboard controller.

The present invention provides a number of important technical advantages. One example of an important technical advantage is that a display configuration dialog box presents available display configurations to a user to allow transition from a selected display configuration state to a desired display configuration state without activating intermediate states. Display configuration selection through the dialog box provides an intuitive interface for users to more quickly and accurately select a display configuration with available display, and reduces waste of system resources by avoiding activation of intermediate display configuration states.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system operable to present a display configuration dialog box for selection of a display configuration;

FIG. 2 depicts an example of a display configuration dialog box; and

FIG. 3 depicts a process for presentation of a display configuration dialog box and selection of an available display configuration with the dialog box.

### DETAILED DESCRIPTION

Information handling system display configuration selection is simplified through presentation of a dialog box with available display configurations and their initiation sequence. A desired display configuration selected through the dialog box is initiated without initiation of intermediate display configurations in the sequence. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

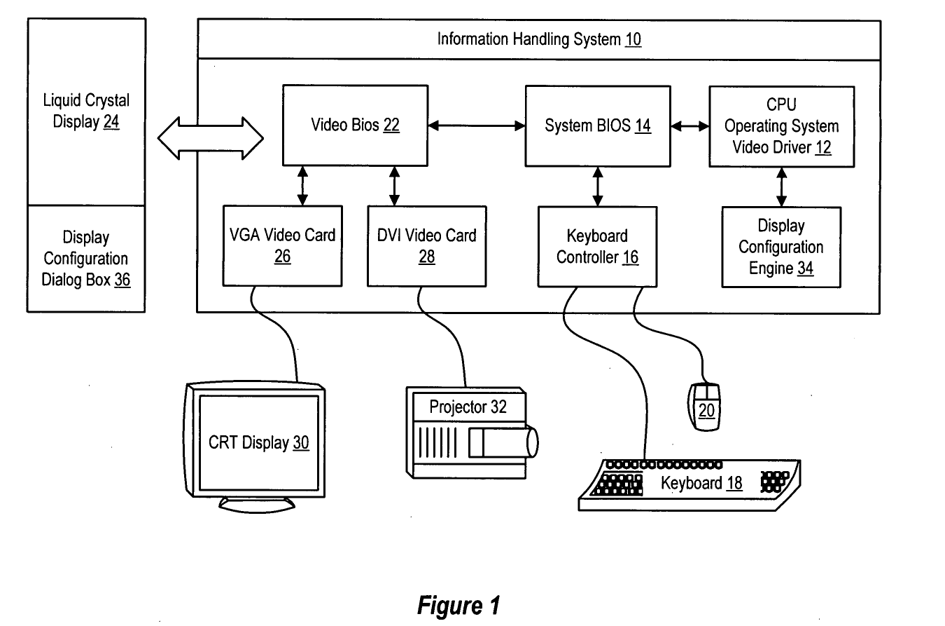

Referring now to FIG. 1, a block diagram depicts a portable information handling system 10 operable to accept display configuration selection through a dialog box presented at a display. Information handling system 10 has a CPU 12 that process information under the direction of an operating system, including information for presentation at a display under the direction of a video driver of the operating system. A system BIOS 14 coordinates interaction of CPU 12 with other physical components of information handling system 10. For instance, BIOS 14 interacts with a keyboard controller 16 that accepts user inputs through a keyboard 18 or mouse 20. BIOS 14 also interacts with a video BIOS 22 to present information through plural video processing units, such as an integrated LCD 24, VGA card 26 and DVI card 28. VGA card 26 outputs a VGA signal through a communication port to display information at VGA compatible display devices, such as CRT display 30. DVI card 28 outputs a DVI signal through a communication port to display information at a DVI compatible display device, such as a projector 32. BIOS 14 defines display configurations, which determine the displays that present information, and an order to sequence through the display configurations in the event of a user request to change the display configuration. For instance, a conventional display configuration sequence order defined by BIOS 14 is: LCD only, LCD and VGA, VGA only, LCD and DVI, DVI only, and CRT and DVI. A conventional BIOS 14 initiates the next display configuration in the sequence at each simultaneous activation of the function and F8 keys.

In order to simplify user interaction with display configuration selection by BIOS 14, a display configuration engine 34 interacts with BIOS 14 during user requests for display configuration changes to present a display configuration dialog box 36. Display configuration engine 34 is, for instance, an application running on CPU 12, such as a module within the operating system video driver. Upon launch of display configuration engine 34, such as during boot of information handling system 10, the display configuration sequence order is retrieved from BIOS 14. The retrieved display configuration sequence order is the complete sequence order used by BIOS 14 if all display processing units have an attached display device, such as the conventional sequence described above.

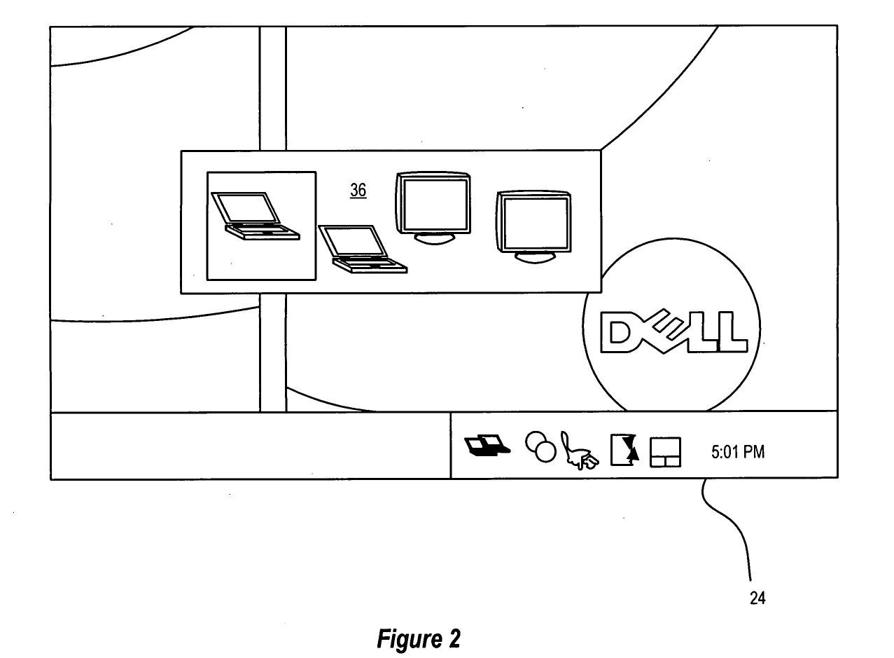

When BIOS 14 detects a request for a display configuration change, such as a user input to keyboard 18 of the function and F8 keys, BIOS 14 detects the available display devices by determining which display processing units has a display device attached and determines the next state in the display configuration which is to be initiated. However, BIOS 14 does not initiate the requested display configuration change, instead sending a scan code to display configuration engine 34 to indicate that the request was made. Display configuration engine 34 retrieves the attached display devices and the next display configuration and generates display configuration dialog box 36. For instance, as depicted by FIG. 2, display configuration dialog box 36 presents the three display configurations available with LCD and VGA display processing units having attached display devices and highlights the LCD only display configuration as the display configuration selected with the current function and F8 key activation. In the example of FIG. 2, no DVI devices are attached to information handling system 10 so that display configuration engine 34 disregards display configurations associated with DVI display devices. The dynamically modified display configuration sequence reduces the consideration of display configurations for selection to those actually available. While the function key remains pressed, each toggle of the F8 key, meaning a release and press, display configuration engine 34 highlights the next display configuration in the sequence presented by dialog box 36 and communicates the selected configuration to BIOS 14. When the function key is released, BIOS 14 initiates of the highlighted display configuration communicated from display configuration engine 34. Selection through dialog box 36 reduces or eliminates the need for BIOS 14 to initiate intermediate display configurations in the sequence order between the initial display configuration and the selected display configuration.

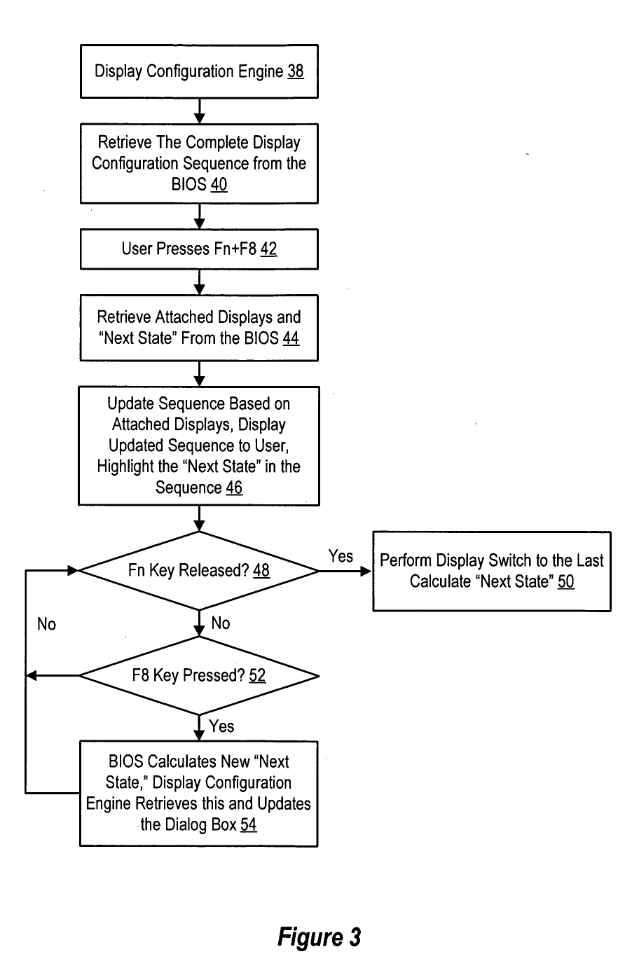

Referring now to FIG. 3, a flow diagram depicts a process for display configuration selection through a display configuration dialog box. The process begins at step 38 with launch of the display configuration engine, such as at information handling system boot. At step 40, the display configuration engine retrieves the complete display configuration sequence from the BIOS. The complete display configuration sequence includes all possible display configurations whether or not a display device is currently attached for each display configuration. At step 42 a user selects a display configuration change, such as by simultaneous selection of the function and F8 keys. At step 44, the display configuration engine retrieves the attached displays and next display configuration in the sequence from the BIOS. At step 46, the display configuration engine applies the information retrieved from the BIOS to dynamically create a modified display configuration sequence for the attached display devices. The modified display configuration sequence is presented to the user in the display configuration dialog box with the next display configuration highlighted to indicate to the user the display configuration selected if the function key is released.

Starting at step 48, the user selects a display configuration by toggling the F8 key with function key pressed and releasing both keys when the desired display configuration is selected. At step 48 a determination is made of whether the function key is released. If yes the process continues to step 50 to command the BIOS to perform a display configuration switch to the last calculated “next” display configuration state. If the determination at step 48 is no, the process continues to step 52 to determine if the F8 key is pressed. If the F8 key is not pressed, the process returns to step 48. If the determination at step 52 is yes, the BIOS calculates a new “next state” from the last-highlighted display configuration state and the display configuration engine retrieves the new “next state” to update the highlighted display configuration dialog box. The process returns to step 48 and repeats to toggle through the available display configurations until the function key is released and the selected display configuration is initiated at step 50.

Although the present invention has been described in detail, it should be understood that various changes, substitutions and alterations can be made hereto without departing from the spirit and scope of the invention as defined by the appended claims.

What is claimed is:

1. An information handling system comprising:
a processor operable to run applications that generate information;
plural display processing units, each display processing unit operable to communicate the information for presentation at one or more display devices;
a keyboard controller operable to accept inputs from a keyboard;
a BIOS interfaced with the processor, the display processing units and the keyboard controller, the BIOS operable to initiate one of plural display configurations of the display processing units to present the information; and
a display configuration engine interfaced with the BIOS and operable to retrieve the plural configurations, to present the plural configurations in a dialog box communicated through one or more of the display processing units, and to communicate to the BIOS a display configuration selected at the dialog box for initiation by the BIOS.

2. The information handling system of claim 1 further comprising:
a housing containing the processor, display processing units, keyboard controller and BIOS;
an LCD integrated with the housing and interfaced with a display processing unit to display the information; and
a keyboard integrated with the housing and interfaced with the keyboard controller to accept user inputs.

3. The information handling system of claim 2 wherein the display processing units comprise at least one VGA unit and at least one DVI unit.

4. The information handling system of claim 3 wherein the keyboard comprises a function key and an F8 key, the display configuration engine further operable to:
display the dialog box upon detection of simultaneous selection of the function and F8 keys;
select a display configuration with detection of F8 key toggles; and
initiate a selected display configuration upon detection of release of the function key.

5. The information handling system of claim 3 further comprising:
a CRT display interfaced with the VGA unit and operable to display the information; and
a projector interfaced with the DVI unit and operable to display the information.

6. The information handling system of claim 3 wherein the display configurations comprise LCD only, LCD and VGA, VGA only, LCD and DVI, DVI only, and VGA and DVI.

7. The information handling system of claim 1 wherein the BIOS is further operable to determine a display configuration selection order and wherein the display configuration engine is further operable to present the display configurations in the dialog box in the selection order.

8. The information handling system of claim 1 wherein the display configuration engine comprises an application running on the processor.

9. The information handling system of claim 1 wherein the display configuration engine comprises firmware associated with the BIOS.

10. A method for selecting an information handling system display configuration, the method comprising:
detecting a request to select a display configuration;
retrieving available display configurations from the BIOS to an application;
presenting with the application the available display configurations in a dialog box at the information handling system;
selecting from the dialog box a desired display configuration; and
commanding the BIOS with the application to initiate the selected display configuration.

11. The method of claim 10 wherein detecting a request further comprises detecting simultaneous activation of function and F8 keys.

12. The method of claim 11 wherein selecting from the dialog box further comprises:
toggling the F8 key to highlight a desired of the available display configurations; and
releasing the function key to select the highlighted display configuration.

13. The method of claim 10 wherein retrieving available display configurations further comprises:
retrieving at launch of the application the complete display configuration sequence order from the BIOS;
retrieving at the application from the BIOS the displays attached to the information handling system; and
determining the available display configurations as those associated with the attached displays.

14. The method of claim 13 wherein presenting with the application the available display configurations further comprises:
determining the next display configuration in the BIOS sequence order; and
highlighting the determined next display configuration.

15. The method of claim 10 wherein the information handling system comprises a portable information handling system having an integrated LCD.

16. The method of claim 15 wherein the portable information handling system comprises a VGA output operable to communicate with a display.

17. The method of claim 16 wherein the portable information handling system comprises a DVI output operable to communicate with a display.

18. The method of claim 17 wherein the display configurations comprise LCD only, LCD and VGA, VGA only, LCD and DVI, VGA and DVI, and DVI only.
